(19) United States
(12) Patent Application Publication
(10) Pub. No.: US 2010/0079665 A1
(43) Pub. Date: Apr. 1, 2010

(54) Frame Interpolation Device

(75) Inventors: Himio Yamauchi, Yokohama-shi (JP); Hiroyuki Michie, Oume-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/475,265

(22) Filed: May 29, 2009

(30) Foreign Application Priority Data
Sep. 26, 2008 (JP) 2008-248963

(51) Int. Cl. H04N 11/02

(52) U.S. Cl. 348/416.1; 348/E07.001

(57) ABSTRACT

A frame interpolation device includes: a motion vector detecting module configured to divide each of input frame images into a plurality of blocks and detect motion vectors by performing block matching; a distribution detecting module configured to detect a distribution of spatial frequency components of a current input frame image; a feature analyzing module configured to analyze a feature of the current input frame image based on the distribution; a control module configured to control the motion vector detecting module according to the detected feature; an interpolation frame generating module configured to generate an interpolation frame image using the detected motion vectors according to the detected feature; and an output module configured to insert the interpolation frame image between the input frame images and output resulting output frame images.

### CROSS REFERENCE TO RELATED APPLICATION(S)

The present disclosure relates to the subject matters contained in Japanese Patent Application No. 2008-248963 filed on Sep. 26, 2009, which are incorporated herein by reference in its entirety.

### FIELD

The present invention relates to a frame interpolation device and method for performing frame interpolation.

### BACKGROUND

In conventional frame interpolation devices, motion vectors obtained by block matching are compared with an average motion vector obtained over the entire image. If patterns of regions indicated by a motion vector are similar, it is determined that a repetitive pattern exists in those regions and the motion vector is changed. An example of such devices is disclosed in JP-A-2007-235403.

However, erroneous detection may tend to occur by use of the technique described in the publication JP-A-2007-235403 because a repetitive pattern is detected only from motion vectors.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 shows a configuration of a frame interpolation device according to the present invention.

FIG. 2 shows the configuration of a frame interpolation device according to the invention in which the frame interpolation processing method is changed from one divisional region to another.

FIG. 3 shows a more detailed configuration of an analyzing module.

FIG. 4 shows the configuration of a frame interpolation device for realizing a first example interpolation frame generation method.

FIG. 5 shows search ranges that are used in determining a motion vector.

FIG. 6 shows the configuration of a frame interpolation device capable of performing a third example method for preventing erroneous detection of a motion vector due to a repetitive pattern.

### DETAILED DESCRIPTION OF THE EMBODIMENTS

Embodiments of the present invention will be hereinafter described with reference to the drawings.

A method for reducing unsmoothness that occurs when a video image is displayed by a hold-display type display device or smoothly displaying a video image such as a movie which is small in the number of frames per second is known. In this method, an interpolation frame is generated from plural successive frames and inserting the generated interpolation frame between original frames used. This method can improve the image quality of the video image.

However, where there is a large image motion between plural successive frames or it is difficult to determine an interframe motion due to a repetitive pattern or the like, a frame interpolation device may detect an erroneous motion from original images. An interpolation frame generated based on such an erroneous motion is different from an image that should be generated. Insertion of such a low-accuracy interpolation frame between original frame images used lowers the image quality contrary to the intention.

In a device described below, a high-accuracy interpolation frame is generated by preventing a frame interpolation device from generating a low-resolution interpolation frame in the above manner.

In order to generate the high-accuracy interpolation frame, the device described below implements frame interpolation method having the following procedure.

First, features of patterns of an original frame image are detected based on the spatial frequency characteristic, that is, the degree of complexity of patterns, of a frame image signal to be used for generating an interpolation frame. An interpolation frame generation method suitable for the image signal is selected according to the detected no features of patterns.

In the following description, details of a configuration and operation of the device will be hereinafter described in detail. In the embodiment, a description will be made of how the interpolation frame generation method is changed to generate a high-accuracy interpolation frame depending on the features of an original frame image of a video image. The configuration of a frame interpolation device according to the embodiment will be described.

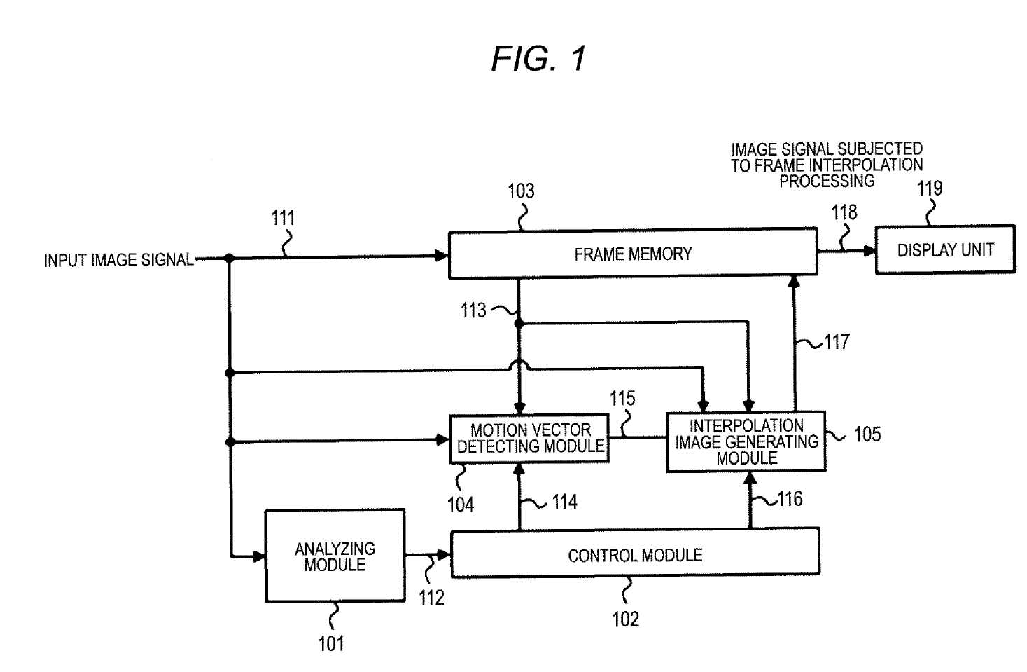

FIG. 1 shows the configuration of a frame interpolation device according to the embodiment.

The frame interpolation device according to the embodiment includes an analyzing module 101 for analyzing features of patterns of an input image, a frame memory 103 for storing the input image, a motion vector detecting module 104 for detecting a motion between plural successive frames, an interpolation image generating module 105 for generating an interpolation frame based on the motion detected by the motion vector detecting module 104, a control module 102 for controlling the motion vector detecting module 104 and the interpolation image generating module 105, and a display unit 119 for displaying an image signal 118 that has been subjected to frame interpolation processing.

Next, the operation of the above-configured frame interpolation device according to the embodiment will be described.

First, an image signal 111 of each frame of a video image is input to the analyzing module 101. The analyzing module 101 extracts features of the image based on a spatial frequency characteristic, that is, the degree of complexity of patterns, of the image signal of the frame, and sends a control signal 112 indicating how to generate an interpolation frame to the control module 102.

On the other hand, while the same frame image signal 111 is recorded in the frame memory 103, the motion vector detecting module 104 performs a search for determining an image variation from an immediately preceding frame image signal 113 and sends a motion vector 115 between the frame images to the interpolation image generating module 105. At this time, block matching is performed in which each image used is divided into plural small blocks and a search is performed to determine a motion vector indicating an interframe motion of each block. The interpolation image generating module 105 generates an interpolation frame image signal 117 based on the motion vectors 115, the image signal 111 of the current frame, and the image signal 113 of the preceding frame according to an interpolation frame generation method control signal 116 which is sent from the control module 102. The interpolation frame is inserted between the two original frames and a resulting image signal 118 that has been subjected to the frame interpolation processing is output.

In the frame interpolation device of FIG. 1, each input frame image is divided into plural regions but the same frame interpolation processing method is employed in all the regions. However, another operation is possible in which each input frame image is divided into plural regions and the frame interpolation processing method is changed from one divisional region to another.

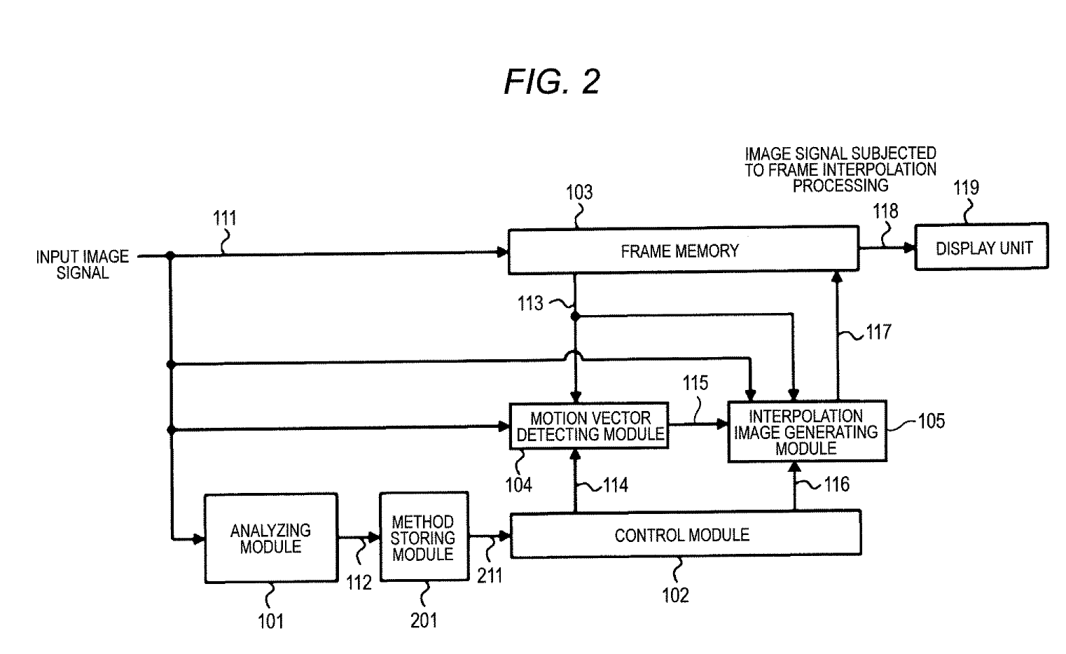

FIG. 2 shows the configuration of a frame interpolation device according to the embodiment in which the frame interpolation processing method is changed from one divisional region to another. The same modules as shown in FIG. 1 will not be described in detail.

Referring to FIG. 2, frame interpolation processing control signals 112 for respective regions of an input frame image are sent to a method storing module 201. In generating an interpolation frame, the control module 102 refers to control signals 211 stored in the method storing module 201.

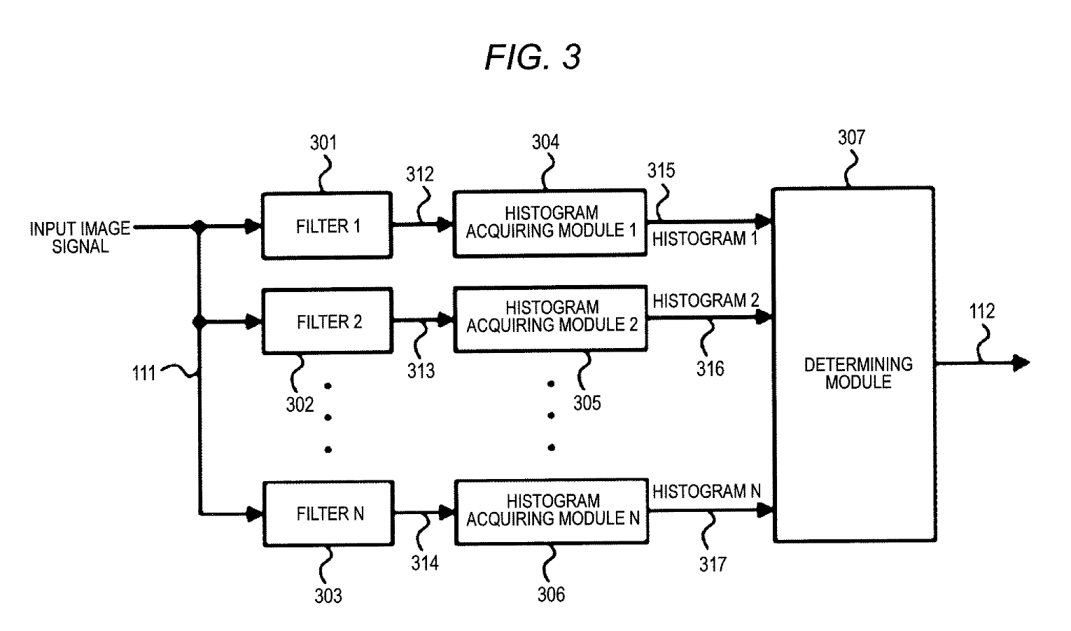

A more detailed configuration and operation of the analyzing module 101 will be described with reference to FIG. 3.

FIG. 3 shows a more detailed configuration of the analyzing module 101.

The analyzing module 101 includes plural filters 301-303 for acquiring plural spatial frequency components, a histogram acquiring module 304-306 for generating histograms from outputs of the filters 301-303, respectively, and an determining module 307 for analyzing features of the image signal based on the histograms that are obtained from the respective histogram acquiring module 304-306.

Next, the operation of the above-configured analyzing module 101 will be described.

First, an input image signal 111 is input to the plural spatial frequency selecting modules (filters) 301-303 having different characteristics. Output signals 312-314 of the filters 301-303 are input to the histogram acquiring modules 304-306, respectively, which generate respective histograms 315-317. The histograms 315-317 reflect components in different frequency ranges of the input image signal 111, respectively.

Therefore, a distribution of spatial frequency components of the input image signal 111, that is, spatial variations of patterns of the image, can be found. The determining module 307 which obtains a distribution of spatial frequency components outputs a control signal 112 which indicates a frame interpolation processing method that is most suitable for the input image signal 111.

A description will be made below of how to detect features of patterns of an input image and generate an interpolation frame according to a detection result in the frame interpolation device according to the embodiment.

A first example of generating interpolation frame will be described below.

Where spatial frequency components of an input image are concentrated only in a low-frequency range, patterns of the image have gentle variations. In this case, when high spatial frequency components are eliminated by reducing the image, the input image suffers only small reduction in image quality and fine variations of patterns are rarely lost. Therefore, if the above feature is detected in a certain region of the input image, the interpolation frame generation method is changed in that region so that a search for determining a motion between successive frames is performed by using a reduced image. An interpolation frame is generated based on resulting motion vectors and the original (i.e., non-reduced) frame image signal.

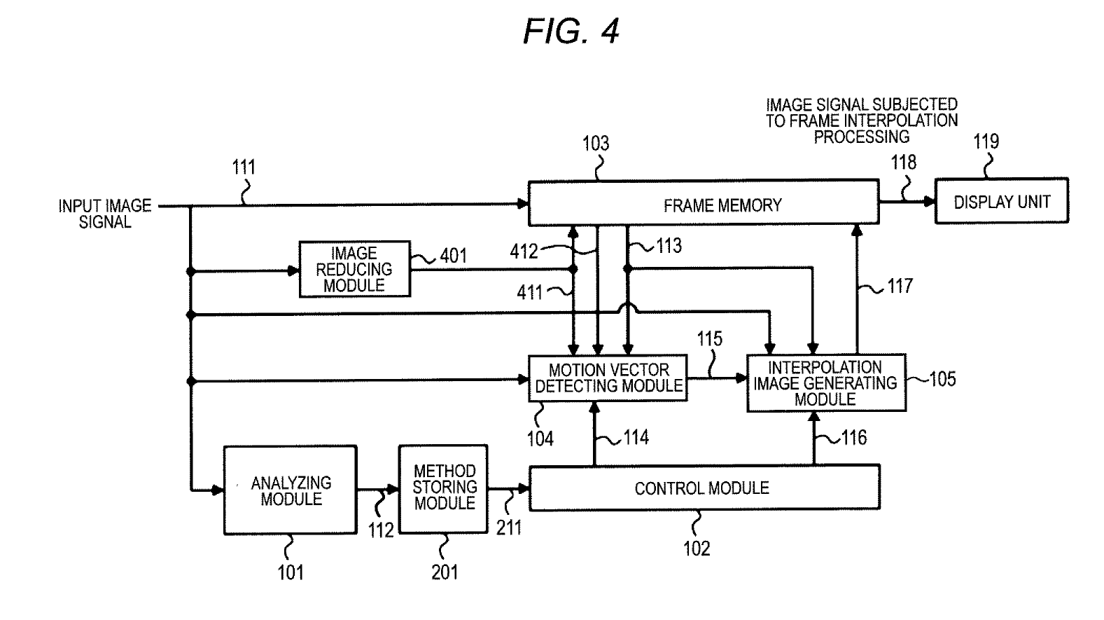

FIG. 4 shows the configuration of a frame interpolation device for realizing the first example no interpolation frame generation method.

Referring to FIG. 4, an input frame image signal 111 is input to the analyzing module 101 and an image reducing module 401. The analyzing module 101 detects features of the input image 111 and sends control signals 112 indicating frame interpolation methods. The control signals 112 are stored in the frame interpolation control method storing module 201. The control signals 112 are sent from the storing module 201 to the control module 102. On the other hand, the image reducing module 401 reduces the input image 111. The original input image 111 and a reduced image 411 which is sent from the image reducing module 401 are stored in the frame memory 103.

In regions of the input frame image 111 where spatial frequency components are concentrated only in a low-frequency rage, a search for determining a motion is performed based on the reduced input image 411 and a 1-frame-preceding reduced input image 412.

In the other regions where spatial frequency components are not concentrated only in a low-frequency rage, a search for determining a motion is performed based on the non-reduced input image 111 and a non-reduced image signal 113 of the preceding frame.

An interpolation image 117 is generated based on thus-obtained motion vectors 115, the frame image signal 111, and the non-reduced image signal 113 of the preceding frame. The interpolation image is inserted between the original frame images and an image signal 118 which has been subjected to the frame interpolation processing is output. This frame interpolation method makes it possible to find a motion in a wider region while preventing reduction in the accuracy of a generated interpolation frame.

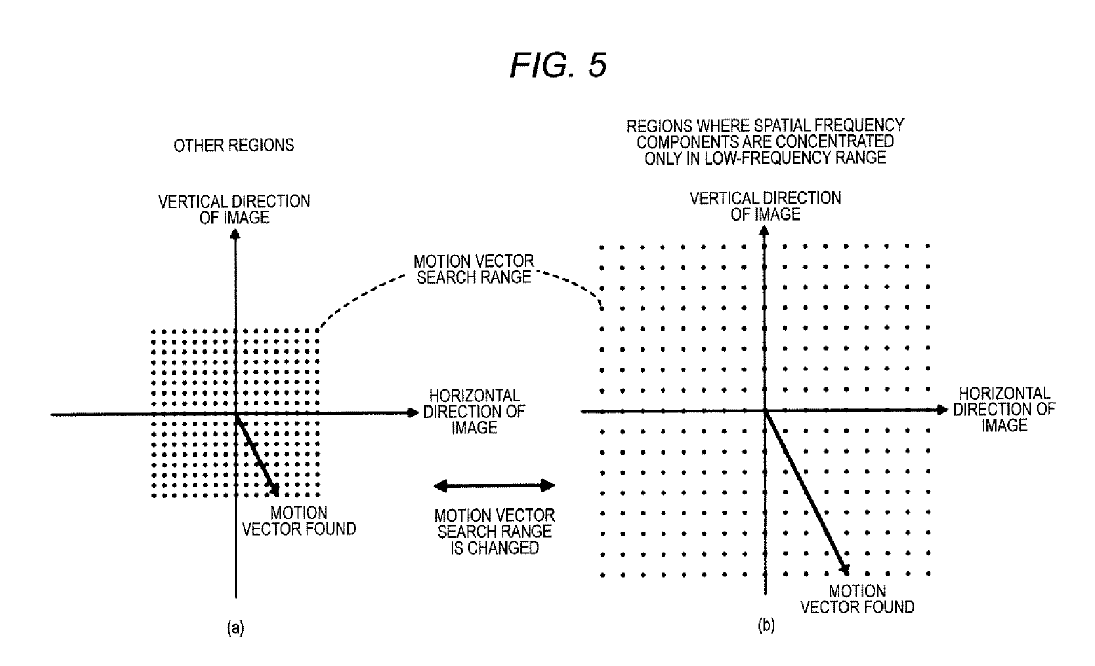

A second example of generating interpolation frame will be described below.

Where spatial frequency components of an input image are concentrated only in a low-frequency range, patterns of the image have gentle variations. In this case, the input image has no fine motions. Therefore, if the above feature is detected in an input image, a group of vectors, which is selectable in a search for determining a motion between successive frames as the motion vector by the motion vector detecting module 104 shown in FIG. 1, is changed. An interpolation frame is generated based on resulting motion vectors and the original image signal. FIG. 5 shows an example in which the group of a motion vector that can be found is changed.

The search range shown in section (b) of FIG. 5, which is used in determining a motion vector, makes it possible to detect a larger motion vector than the search range shown in section (a) of FIG. 5 while the total number of candidate motion vectors is kept the same. Conversely, the search range shown in section (a) of FIG. 5 makes it possible to detect a finer motion than the search range shown in section (b) of FIG. 5 because the interval between adjacent candidate motion vectors is smaller in the former search range than in the latter one.

Therefore, in the second example interpolation frame generation method, a wider search range as shown in section (b) of FIG. 5 is used in regions where spatial frequency components of an input image are concentrated only in a low-frequency range and a smaller search range as shown in section (a) of FIG. 5 is used in other regions. This frame interpolation method makes it possible to find a motion in a wider region while preventing reduction in the accuracy of a generated interpolation frame.

A third example of generating interpolation frame will be described below. Where spatial frequency components of an input image are concentrated only in a low-frequency range, patterns of the image have gentle variations. In this case, in the input image, similar patterns occupy a wide region. Therefore, due to noise etc. in the image, a motion vector that is different from a motion vector that should be selected is prone to be selected by block matching. In view of this, if the above feature is detected in an input image, in a search for determining a motion between successive frames the motion vector detecting module 104 shown in FIG. 1 increases the block size of block matching to compare patterns in a wider region. With this measure, a pattern variation appears more likely in each block of the block matching and a motion vector that should be selected is more apt to be selected. An interpolation frame is generated based on resulting motion vectors and the original frame image signal. This frame interpolation method makes it possible to generate a more accurate interpolation frame.

A fourth example of generating interpolation frame will be described below. Where spatial frequency components of an input image are concentrated in a certain frequency range, the input image has a repetitive pattern. In view of this, frame interpolation is performed by changing the frame interpolation method so as to prevent erroneous detection of a motion between frames due to a repetitive pattern.

In connection with the above fourth example interpolation frame generation method, example methods for preventing erroneous detection of a motion vector due to a repetitive pattern will be described below sequentially.

The reason why erroneous detection of a motion vector tends to occur in an image having a repetitive pattern is that several kinds of motion can be found in a region having the repetitive pattern and hence it is difficult to determine a proper motion. In particular, an erroneous motion vector tends to be found when the position of a repetitive pattern slightly moves between two successive frames or a repetitive pattern varies slightly due to noise or the like.

In a first example method for preventing erroneous detection of a motion vector due to a repetitive pattern, the motion vector search range in the motion vector detecting module 104 shown in FIG. 1 is changed so as to be narrower than the region of the repetitive pattern. This is effective because refraining from referring to the next repetition cycle of a repetitive pattern in block matching reduces the number of candidate motion vectors in a motion vector search and hence lowers the probability of selection of an erroneous motion vector. This method makes it possible to prevent reduction in the accuracy of an interpolation frame due to a repetitive pattern.

In a second example method for preventing erroneous detection of a motion vector due to a repetitive pattern, the range of motion vectors that can be used in the interpolation image generating module 105 shown in FIG. 1 is made narrower than usual.

To this end, the interpolation image generating module 105 is made a device capable of changing the range of motion vectors that can be used with respect to the range of motion vectors detected by the motion vector detecting module 104. A technique disclosed in JP-A-2008-067205 may be employed as a technique for narrowing the range of motion vectors that can be used in the interpolation image generating module 105. The interpolation image generating module 105 narrows the range of motion vectors to be used with respect to the range of detected motion vectors and uses resulting motion vectors for generation of an interpolation frame.

In this case, an interpolation frame is generated by using motion vectors that are reduced from original motion vectors, which reduces the effect of the frame interpolation. However, the image quality reduction can still be decreased because the reduction in the accuracy of an interpolation frame due to motion vectors that have been detected erroneously due to a repetitive pattern is decreased.

In a third example method for preventing erroneous detection of a motion vector due to a repetitive pattern, large variation between a motion vector of a certain block and a motion vector of a block that is adjacent to the former block spatially or temporally is prohibited more strictly. A technique disclosed in JP-A-2008-067222 (counterpart U.S. publication is: US 2008/0063289 A1) may be used as a technique for smoothing motion vectors. The publication JP-A-2008-067222 discloses a technique for controlling the function of filtering on motion vectors according to features of an input image signal.

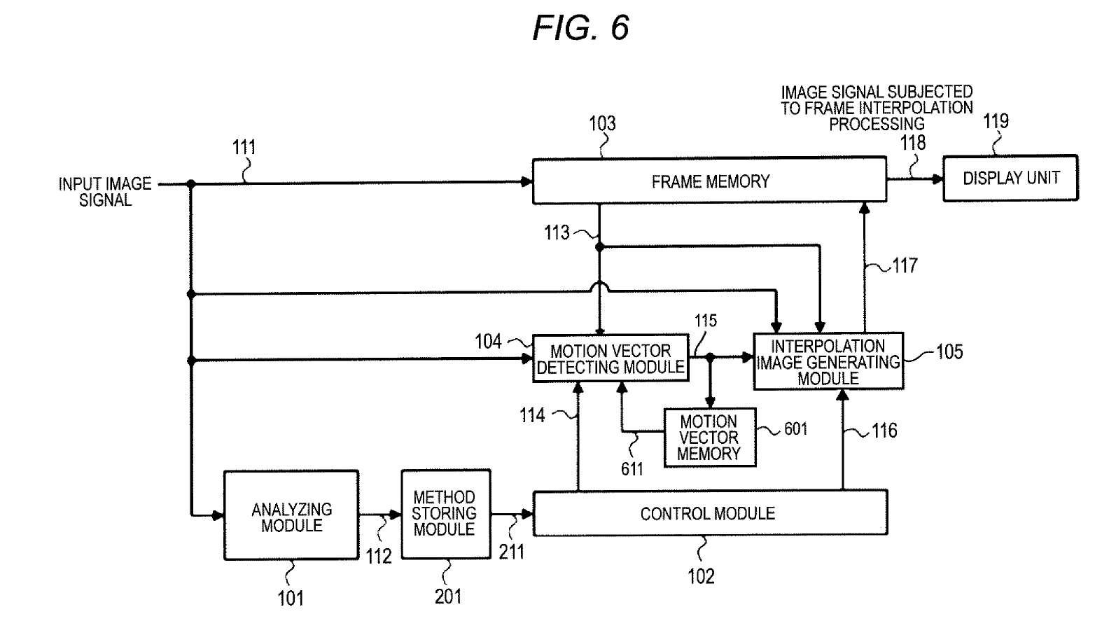

FIG. 6 shows the configuration of a frame interpolation device capable of performing the third example method for preventing erroneous detection of a motion vector due to a repetitive pattern.

Referring to FIG. 6, motion vectors 115 of one frame that have been found by the motion vector detecting module 104 are stored in a motion vector memory 601. In a motion vector search for the next frame, motion vectors 611 of blocks around a motion search block and a motion vector 611, detected one frame before, of the block at the same position are sent from the motion vector memory 601 to the motion vector detecting module 104. A motion vector found is changed so as not to be much different from the neighboring motion vectors 611. In particular, when a repetitive pattern is detected in an input frame image, differences from neighboring motion vectors are corrected more strongly. With this method, a motion vector that has been detected erroneously due to a repetitive pattern is corrected by using correctly detected neighboring motion vectors, whereby reduction in the accuracy of a generated interpolation frame 117 can be prevented.

As described above, the device according to the embodiment analyzes an input image signal based on a distribution of its spatial frequency components and an analysis result is reflected in the interpolation frame generation method. This makes it possible to provide a high-accuracy interpolation frame generation method and device which are lower in the probability of occurrence of failures.

In the device according to the embodiment, a repetitive pattern is detected based on a spatial frequency characteristic of an input image signal and a detection result is reflected in the interpolation frame generation method. This also contributes to providing a high-accuracy interpolation frame generation method and device which are lower in the probability of occurrence of failures.

Although the embodiments according to the present invention have been described above, the present invention is not limited to the above-mentioned embodiments but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A frame interpolation device for generating a new interpolation frame image to be inserted between input frame images using two or more of the input frame images, the device comprising:
a motion vector detecting module configured to divide each of the input frame images into a plurality of blocks and detect motion vectors of objects in the input frame images for each of the blocks by performing block matching between the input frame images;
a distribution detecting module configured to detect a distribution of spatial frequency components of a current input frame image;
a feature analyzing module configured to analyze a feature of the current input frame image based on the distribution of the spatial frequency components detected by the distribution detecting module;
a control module configured to control the motion vector detecting module according to the feature detected by the feature analyzing module;
an interpolation frame generating module configured to generate an interpolation frame image using the detected motion vectors according to the feature detected by the feature analyzing module; and
an output module configured to insert the interpolation frame image generated by the interpolation frame generating module between the input frame images and output resulting output frame images.

2. The device of claim 1, wherein the feature analyzing module detects whether the spatial frequency components of the current input frame image are concentrated only in a low-frequency range, and
wherein the control module controls the motion vector detecting module to:
change images to be used for detection of the motion vectors from the input frame images to images obtained by reducing the input frame images when the spatial frequency components of the current input frame image are concentrated only in a low-frequency range; and
keep the images to be used for detection of the motion vectors unchanged when the spatial frequency components of the current input frame image are not concentrated only in a low-frequency range.

3. The device of claim 1, wherein the feature analyzing module detects whether the spatial frequency components of the current input frame image are concentrated only in a low-frequency range, and
wherein the control module controls the motion vector detecting module to:
change a group of vectors, which is selectable in a search for determining a motion between successive frames as the motion vector by the motion vector detecting module, when the spatial frequency components of the current input frame image are concentrated only in a low-frequency range; and
keep the group of vectors unchanged when the spatial frequency components of the current input frame image are not concentrated only in a low-frequency range.

4. The device of claim 1, wherein the feature analyzing module detects whether the spatial frequency components of the current input frame image are concentrated only in a low-frequency range, and
wherein the control module controls the motion vector detecting module to:
change a block size of the block matching when the spatial frequency components of the current input frame image are concentrated only in a low-frequency range; and
keep the block size of the block matching unchanged when the spatial frequency components of the current input frame image are not concentrated only in a low-frequency range.

5. The device of claim 1, wherein the feature analyzing module detects whether the current input frame image has a repetitive pattern by detecting whether the spatial frequency components of the current input frame image are concentrated in a particular frequency range, and
wherein, when the feature analyzing module analyzes that a repetitive pattern exists in the current input frame image, the control module controls the interpolation frame generating module to select a frame interpolation method, from a plurality of available methods, to be employed for generating the interpolation frame image while preventing erroneous interpolation due to the repetitive pattern

6. The device of claim 1 further comprising a display unit configured to display the output frame images.

7. A method for performing frame interpolation for generating a new interpolation frame image to be inserted between input frame images using two or more of the input frame images, the method comprising:
dividing each of the input frame images into a plurality of blocks;
detecting motion vectors of objects in the input frame images for each of the blocks by performing block matching between the input frame images;
detecting a distribution of spatial frequency components of a current input frame image;
analyzing a feature of the current input frame image based on the distribution of the spatial frequency components;
controlling the motion vector detecting module according to the detected feature;
generating an interpolation frame image using the detected motion vectors according to the detected feature; and
inserting the interpolation frame image generated by the interpolation frame generating module between the input frame images.
